(19) United States
(12) Patent Application Publication
(10) Pub. No.: US 2004/0118893 A1
(43) Pub. Date: Jun. 24, 2004

(54) Transport device for inserting a web into a web processing machine

(76) Inventors: Martin Richard Keller, Karlstadt (DE); Erwin Paul Josef Lehrieder, Gaukonigshofen (DE)

Correspondence Address: Douglas R Hanscom, JonesTullar & Cooper, Eads Station, P O Box 2266, Arlington, VA, 22202, US

(21) Appl. No.: 10/474,196

(22) PCT Filed: Mar. 15, 2002
(86) PCT No.: PCT/DE02/00931

(30) Foreign Application Priority Data
Apr. 18, 2001 (DE) 101 18 868.4

(51) Int. Cl. B41F 13/03

(52) U.S. Cl. 226/91

(57) ABSTRACT

A transfer device, which is usable for inserting a web into a web processing machine, includes at least one transport chain that is displaceable in a guide element. At least one driving device engages the transport chain while it is in the guide element. The guide element has at least one section, which is adjacent the driving device, that can be moved or displaced in a lateral direction in relation to the direction of transport. Each point of this section is displaceable in a direction of movement away from the driving device.

Transport Device for Inserting a Web into a Web Processing Machine The invention relates to a transport device for drawing a web into a web-processing printing press in accordance with the preamble of claim 1.

A device for drawing in a web of material is known from DE 30 18 740 A1, wherein a conveyor chain is movable in a guide device and can be driven by means of a chain wheel. In order to assure the dependable feeding of the conveyor chain even in case of an unfavorable relative position between the start of the chain and the chain wheel, the guide rail in an example is embodied as a rocker around a fixed point in the area of the chain wheel, and in a second example by U-shaped punched-out tongues.

In order to prevent the jamming of the chain and the drive wheel in the course of feeding a conveyor chain into the effective area of the drive wheel, it is furthermore known to arrange the entire drive motor for the drive wheel to be movable in relation to a guide device which is guiding the chain.

U.S. Pat. No. 1,288,550 shows a spring-loaded protection device for an endless roller chain.

DE 299 05 965 U1 describes a guide chain for bracing an endless roller chain.

The object of the invention is based on creating a transport device for drawing a web into a web-processing printing press.

In accordance with the invention, this object is attained by means of the characteristics of claim 1.

The advantages to be gained by means of the invention rest in particular in that the jamming of the drive mechanism and the chain, in particular a transport chain, is prevented, without it being necessary to provide an increased structural outlay for the seating of the motors.

At the same time, by means of the invention a dependable, interference-free guidance of the transport chain over the entire area of the interaction with the drive means is achieved, since every point of a partial element of the guide device is reversibly deflectable transversely to the transport direction in the mentioned area. In an advantageous manner, this partial element as a whole is embodied to be movable away from the drive means.

In particular it is also advantageous that it permits the use and modification of conventional guide devices, and therefore already existing transport devices can be retrofitted without increased outlay by means of the steps of the instant transport device.

It is also possible to omit elaborate drive mechanisms whose angle of rotation is controlled, since the partial element of the guide device adjoining the drive means compensates a possibly occurring offset between adjoining drive means and the transport chain.

In an advantageous embodiment only the partial element of a C-shaped guide device facing away from the drive means is separated from the back and partial element of the guide device facing the drive means, and is arranged to be reversibly movable away from the drive means with the aid of two springs, for example pressure springs.

Because it saves structural space, an also advantageous embodiment provides the embodiment of the springs as extension springs, which maintain the movable partial element in its normal position in respect to the drive means as a closed letter “C”.

A simple, cost-effective and rugged construction is advantageous, for example by means of two bolts, which penetrate through the “C” in the area of its back, wherein a spring force maintaining the “C” in its normal position can be adjusted by means of nuts to constitute an abutment.

Exemplary embodiments of the invention are represented in the drawings and will be described in greater detail in what follows.

Shown are in:

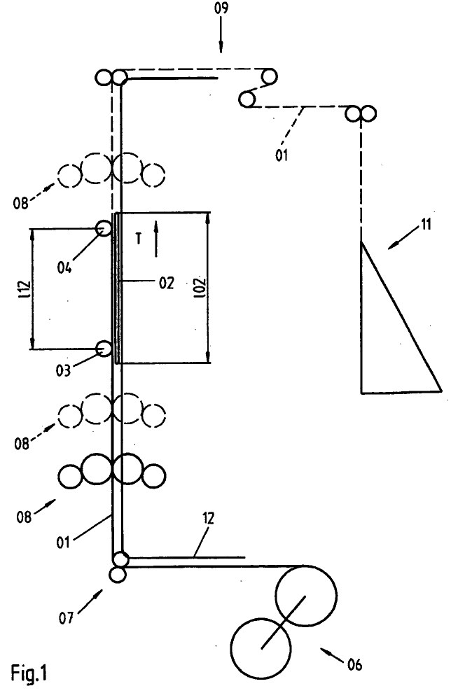

FIG. 1, a schematic representation of a web-fed rotary printing press,

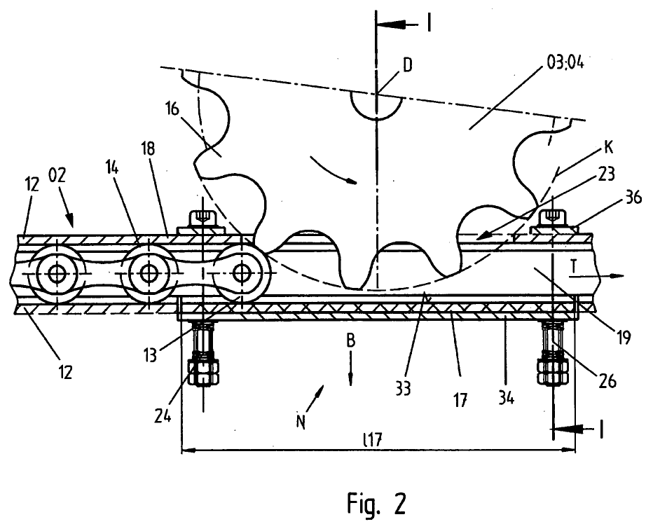

FIG. 2, a transport device with a transport chain in a guide device, a partial element of which can be deflected, and a chain wheel (partially in section),

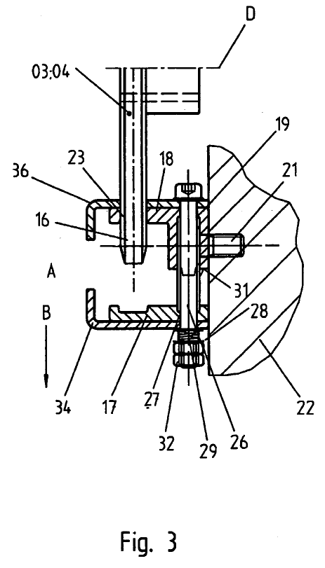

FIG. 3, a section (I-I) in accordance with FIG. 2,

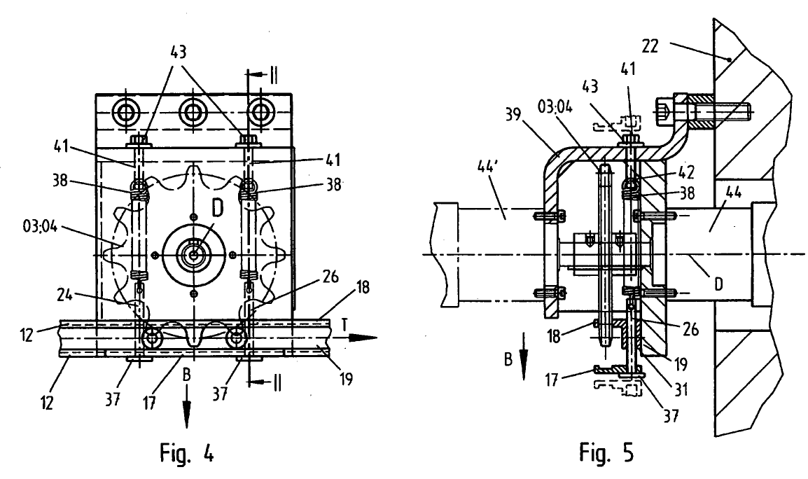

FIG. 4, a transport device in accordance with a second exemplary embodiment,

FIG. 5, a section (II-II) in accordance with FIG. 4.

A transport device for transporting a web 01, for example a web of material, in or through a processing printing press for processing the web, in particular for drawing a web 01 to be imprinted into a web-fed rotary printing press, has a transport means 02, for example a transport chain 02 and at least one drive means 03, 04 driving the transport chain 02.

For example, the web 01 to be imprinted is drawn off a roll support 06 by means of a draw-in unit 07, drawn through one or several printing groups 08 and, if a suitable installation is provided, also through a superstructure 09 (turning and or cutting area) and a hopper area 11 into the web-fed rotary printing press (only schematically represented in FIG. 1). Viewed in the transport direction T, the course of the web 01 is represented in dashes after the transport means 02.

For this purpose, the start of the web 01 to be imprinted is arranged on the transport chain 02, for example by means of a draw-in tip and a coupling element, not represented. The preferably finite transport chain 02 is arranged in a guide device 12 (see FIGS. 2 and 4), which extends along the desired and preselected path of the web 01. The guide device 12 can contain shunts which make possible the various transport paths. In an advantageous embodiment the guide device 12 is embodied as a rail 12 with a C-shaped profile.

Driving of the transport chain 02 is performed for example from electric motors, not represented in FIG. 1, to drive means 03, 04, which are spaced apart from each other along the guide device 12 at a distance 112, which is less than a length 102 of the transport chain 02, so that on its travel through the web-fed rotary printing press the transport chain 02 acts together with respectively at least one drive means 03, 04, and prior to leaving the one drive means 03, it already acts together with the following drive means 04.

The transport chain 02 (FIG. 2) has links 13, 14 arranged spaced apart from each other in the transport direction T which, used as stops, act together positively connected or at least in a driven connection, with a driver 16 of the drive means 03, 04, for example tooth flanks of teeth 16 of a chain wheel 03, 04. The transport chain 02 can be embodied as a link chain, as a finite belt of an appropriate texture, or in other ways, which has stops acting in the transport direction T on its side collaborating with the driver 16. An axis of rotation D of the chain wheel 03, 04 is preferably arranged fixed on the frame of the printing press.

If now the first roller 13 of the leading end of the transport chain 02 comes within the range of the teeth 16 of the chain wheel 04, the area of the trailing end of the transport chain 02 still cooperates with the previous chain wheel 03 which still pushes the transport chain 02 in the transport direction T.

With an unfavorable angular position of the chain wheel 04 rotating around the axis of rotation D, the first link 13, for example the first roller 13, which is being pushed in the transport direction T, tends to block the chain wheel 04 since, in case of a rigid guidance, it can neither turn aside, nor can relief opposite the transport direction T be provided, i.e. counter to the push of the previous chain wheel 03.

For this purpose, in an area adjoining the chain wheel 03, 04, i.e. at least over a length 112 of the guide device 12 on which the teeth 16 of the chain wheel 03, 04 and the rollers 13, 14 of the transport chain 02 work together, a partial element 17 of the guide device 12, for example the leg 17 of the C-shaped guide device 12, is embodied to be movable transversely to the transport direction T and away from the chain wheel 03, 04 in a movement direction B.

In a first exemplary embodiment in accordance with FIGS. 2 and 3, in the area of the chain wheels 03, 04 the C-shaped guide device 12 has the leg 17 located remote from the chain wheel 03, 04, a leg 18 located closest to the chain wheel 03, 04, and a back 19 arranged between the legs 17, 18. In the area of the back 19, the guide device 12 is fastened, for example by means of screws 21, to a wall 22 fixed on the printing press.

For the purpose of conveying the transport chain 02, the chain wheel 03, 04 enters into the guide device through a cutout 23 in the leg 18 located closest to the chain wheel 03, 04. The leg 17 located remote from the chain wheel 03, 04 is arranged to be deflectable at least over a length 117 in relation to the chain wheel 03, 04 and transversely to the transport direction T which is greater than or equal to a length on which a tip circle K of the chain wheel 03, 04 would intersect the imaginary movement path of the transport chain 02 without the deflection of the leg 17.

For this purpose, the leg 17 is arranged so it can be separated from the back 19, and it is not fixedly connected with the remaining portions of the guide device 12. Two bolts 24, 26, which are arranged spaced apart from each other in the transport direction T, extend along the movement direction B, i.e. almost perpendicularly in relation to the transport direction T and almost perpendicularly to the axis of rotation D of the chain wheel 03, 04, in the area of the back 19 of the C-shaped guide device 12, and project out of the back 19 at least on the side of the back 19 facing away from the chain wheel 03, 04. They are respectively received in a cutout 27 arranged in the leg 17, for example a bore 27, so that the leg 17 can be moved in the movement direction B almost perpendicularly in relation to the transport direction T and almost perpendicularly to the axis of rotation D of the chain wheel 03, 04, and guided linearly to a large extent. If the bore 27 is embodied as an elongated hole with an orientation in the transport direction T, tilting, or a movement in a direction inclined in respect to the perpendicular direction, is possible, besides a linear movement. The movement of the leg 17 then points to the plane extending perpendicularly in respect to the axis of rotation D.

A spring 29, in particular a pressure spring 29, which presses the leg 17 against the back 19, is arranged between the leg 17 and an abutment 28 on the end of the bolt 24, 26 facing away from the chain wheel 03, 04. In an advantageous manner, the abutment 28 is arranged so it can be displaced along the longitudinal axis of the bolts 24, 26 and, in the example, is embodied as a disk 28 with a nut 32, which is movably arranged on an exterior thread of the bolt 24, 26. In a normal position “N”, the spring 29 pushes the leg 17 against a stop 31, in the example the side of the back 19 facing the leg 17 (FIG. 2). FIG. 3 shows the leg 17 in a deflected position “A”.

In Hooke's area of the spring 29 in particular, the spring force required for deflection can be for one adjusted, and otherwise a simple readjustment within certain limits is possible in case of fatigue. An unintentional deflection, or a deflection because of too strong a force, and the problems resulting therefrom regarding the driving of the transport chain 02, can be prevented by a simple adjustment.

The exact connection of a running face 33 of the rollers 13, 14 is achieved in that in its normal position “N” the leg 17 is pushed against the underside of the back 19 acting as a stop 31.

In the example, a protective device 34, 36 is arranged on the guide device 12 on each leg 17, 18 in the area of the chain wheel 03, 04, wherein the protective device 34 which is remote from the chain wheel 03, 04 is embodied to be deflectable together with the leg 17, and the protective device 36 closest to the chain wheel 03, 04 is fixed in place on the printing press and also has a cutout for the chain wheel 03, 04.

In a second exemplary embodiment (FIGS. 4 and 5), the bolt 24, 26 extends through the leg 17 and the back 19 connected with the leg 18, wherein the end of the bolt 24, 25 facing the chain wheel 03, 04 projects out of the leg 18 fixed in place on the printing press, and the opposite end is connected with the deflectable leg 17. The latter can be accomplished as in the example by means of a stop 37 arranged on the bolt 24, 26, which acts together with the leg 17. The longitudinal axis of the bolt 24, 26 is again oriented almost perpendicularly in respect to the transport direction T and perpendicularly with the axis of rotation D of the chain wheel 03, 04, and can be moved in the guide device 12 along this axis of rotation. The end of the bolt 24, 26 projecting out of the side of the guide device 12 facing the chain wheel 03, 04 is connected with a spring 38, for example an extension spring 38, whose second end is fixed in place on the frame in such a way that the active direction of the extension spring 38 has a component in the axial direction of the bolt 24, 26 and opposite the movement direction B.

In the exemplary embodiment, the end of the extension spring 38 fixed in place on the frame is arranged on a holder 39 arranged on the wall 22 by means of a bolt 41 extending through the holder 39. For this purpose, on its end facing the extension spring 38, the bolt 41 has, for example, an eye 42 for receiving a bent end of the extension spring 38, and at least in the area of the holder 39 and on its end facing away from the extension spring 38, it has an exterior thread which works together with a nut 43 as the abutment 43 for the extension spring 38, or as a stop 43, for adjustment.

The arrangement of the extension spring 38 has been made in such a way that the pre-tension of the extension spring 38 pulls the deflectable leg 17 against the back 19, or the stop 31 of the guide device 12 for forming the closed “C”.

The embodiment of the transport device in accordance with the second example is particularly advantageous in regard to the structural space if, as indicated by dashed lines in FIG. 5, a second guide device is intended to extend parallel with the guide device 12. The extension spring 38 and substantial parts of the bolt 24, 26 are arranged on the side of the guide device 12 of the deflectable leg 17 facing away from the chain wheel 03, 04.

The embodiment of the holder 38 is advantageous in that in its further extension a motor 44, which drives the chain wheel 03, 04, can be arranged facing away from the side of the wall 22, as well as from the side of the chain wheel 04 (44′, in dashed lines) facing away from the wall 22.

Because of the movable seating of the partial element 17 of the guide device 12 in the entire reciprocably acting area, jamming is also made impossible in the case where a transport chain, which does not exactly engage the chain wheel, can avoid the chain wheel 03, 04 also in its further path through the area of the chain wheel 03, 04.

The transport device functions as follows:

The transport chain 02 moves on its path through the printing press for the purpose of transporting the web 01 fastened to it. In the course of this, on a portion of its path the first link 13 of the transport chain 02 comes into the range of the drivers 16 of the drive means 04, for example into the tip circle of the chain wheel 04, while in the area of its trailing end the transport chain 02 still works together with a preceding drive means 03, which pushes the transport chain 02 in the transport direction T.

In case of an unfavorable relative position between the driver 16 and the first link 13, or its stop 13, the driver 16 encounters the link 13 in such a way that they threaten to block each other. For example, a tooth 16 of the chain wheel 04 does not enter into the space between the rollers 13, 14 and instead presses on the roller 13.

The component of the force exerted by the tooth 16 on the roller 13, which extends almost perpendicularly to the transport direction T and perpendicularly to the axis of rotation D of the drive means 04, now causes a movement of the roller 13 and the deflectable leg 17 in the movement direction B, so that the continued turning of the drive means 04 and an assured further transport of the transport chain 02 is made possible without a blockage.

### List of Reference Symbols

01 Web, web of material to be imprinted

02 Transport means, transport chain, roller chain

03 Drive means, chain wheel

04 Drive means, chain wheel

05 -

06 Roll support

07 Draw-in mechanism

08 Printing group

09 Superstructure

10 -

11 Hopper area

12 Guide device, rail

13 Link, roller

14 Link, roller

15 -

16 Driver, tooth (03, 04)

17 Partial element, leg (12)

18 Leg (12)

19 Back (12)

20 -

21 Screw

22 Wall

23 Cutout (18)

24 Bolt

25 -

26 Bolt

27 Cutout, bore (17)

28 Abutment, disk

29 Spring, pressure spring

30 -

31 Stop

32 Nut

33 Running face (13, 14)

34 Protective device

35 -

36 Protective device

37 Stop

38 Spring, extension spring

39 Holder

40 -

41 Bolt

42 Eye

43 Nut, abutment, stop

44 Motor

44′ Motor, second position

A Deflected position

B Movement direction (17)

D Axis of rotation (03, 04)

K Tip circle (04)

N Normal position

T Transport direction (02)

102 Length (02)

112 Length (03, 04)

117 Length (17)

1. A transport device for drawing a web into a web-processing printing press, having at least one finite transport chain (02) arranged, movable in the transport direction (T), in a guide device (12), and having a drive means (03, 04) which comes into contact with the transport chain (02) at least at times, wherein a partial element (17) of the guide device (12) adjoining the drive means (03, 04) can be deflected transversely to the transport direction (T) out of a normal position (N) when the leading end of the transport chain (02) comes into contact with the drive means (03, 04), characterized in that every point of the partial element (17) of the guide device (12) can be deflected into a movement direction (B) away from the drive means (03, 04).

2. The transport device in accordance with claim 1, characterized in that the partial element (17) of the guide device (12) as a whole can be deflected into a movement direction (B) away from the drive means (03, 04).

3. The transport device in accordance with claim 1, characterized in that the partial element (17) of the guide device (12) is reversible and automatically returnable and, as a result of a contact between the drive means (03, 04) and the transport chain (02), is deflectable.

4. The transport device in accordance with claim 1, characterized in that the partial element (17) of the guide device (12) can be deflected along the movement direction (B), which extends almost perpendicularly in respect to the transport direction (T) and approximately perpendicularly to an axis of rotation (D) of the drive means (03, 04).

5. The transport device in accordance with claim 3, characterized in that the partial element (17) can be returned from a deflected position (A) into a normal position (N) by means of at least one spring (29, 38).

6. The transport device in accordance with claim 5, characterized in that the deflection out of the normal position (N) takes place opposite a spring force of the spring (29, 38).

7. The transport device in accordance with claim 5, characterized in that in the normal position (N), the deflectable partial element (17) can be prestressed opposite the movement direction (B) by means of the spring (29, 38) against a stop (31), which defines the normal position (N).

8. The transport device in accordance with claim 6, characterized in that the spring force of the spring (29, 38) acting opposite the movement direction (B) on the deflectable partial element (17) of the guide device (12) can be changed.

9. The transport device in accordance with claim 5, characterized in that the spring (29, 38) is arranged between an abutment (28, 34) which is fixed in place on the printing press in regard to the movement direction (B) and the deflectable partial element (17).

10. The transport device in accordance with claim 8 and 9, characterized in that a distance between the abutment (28, 43) and the deflectable partial element (17), which defines the spring force of the spring (29, 38), can be changed.

11. The transport device in accordance with claim 4 and 5, characterized in that the deflectable partial element (17) has cutouts (27), and is seated, movable in the movement direction (B), by means of two bolts (24, 26), which work together with the cutouts (27), are spaced apart from each other in the transport direction (T) and are arranged on the portions (18, 19) of the guide device (12) which are fixed in place on the printing press.

12. The transport device in accordance with claim 9 and 11, characterized in that on its end remote from the guide device (12), the bolt (24, 26) has the abutment (28), and that the spring (29) embodied as a pressure spring (29) is arranged on the bolt (24, 26) between the abutment (28) and the partial element (17).

13. The transport device in accordance with claim 9 and 11, characterized in that the bolt (24, 26) is positively connected with its one end with the partial element (17), and on its other end is connected via the spring (38) embodied as an extension spring (38) with the abutment (43), which is fixed in place on the printing press in regard to the movement direction (B).

14. The transport device in accordance with claim 13, characterized in that the means (24, 26, 29, 38) which cause the restoration of the partial element (17) are arranged to a large extent on the side of the movable partial element (17) facing the drive means (04).

15. The transport device in accordance with claim 1, characterized in that the printing press is embodied as a web-fed rotary printing press, and the web (01) as a web (01) of material to be imprinted.
